(19) United States
(12) Patent Application Publication
(10) Pub. No.: US 2015/0199883 A1
(43) Pub. Date: Jul. 16, 2015

(54) Hand Sanitation Dispensing and Tracking Systems and Methods

(71) Applicants: Kaylin Wayne Hartley, Blaine, WA (US); Bruce Selwood Hartley, Blaine, WA (US); Julie Ann Merfeld, Peosta, IA (US)

(72) Inventors: Kaylin Wayne Hartley, Blaine, WA (US); Bruce Selwood Hartley, Blaine, WA (US); Julie Ann Merfeld, Peosta, IA (US)

(21) Appl. No.: 14/597,020

(22) Filed: Jan. 14, 2015

Related U.S. Application Data
(60) Provisional application No. 61/927,786, filed on Jan. 15, 2014.

(51) Int. Cl. G08B 3/10; G08B 21/22; A47K 5/06

(52) U.S. Cl. CPC G08B 3/10; A47K 5/06; G08B 21/22

(57) ABSTRACT

A hand sanitation dispensing and tracking system is disclosed that encourages proper hand sanitization to maintain cleanliness and limit the spread of harmful pathogens. More specifically, a system is provided that detects the approach of a person to an area where it is desirous to limit the spread of germs, provides escalating notifications to the person to sanitize their hands, tracks whether the person uses the sanitizer, and records the information for later statistical analysis. Moreover, the system is small and portable thereby allowing it to be effective in remote areas, or in areas where electricity is not readily available or reliable.

### CROSS REFERENCE TO RELATED APPLICATIONS

This application claims priority to U.S. Provisional Patent Application No. 61/927,786, filed on Jan. 15, 2014, entitled Mandatory Hand Sanitizer Solution Dispensing Device and Tracking System, which is incorporated by reference in its entirety.

### FIELD OF THE INVENTION

The present invention relates generally to systems and methods for encouraging hand sanitation best practices, and more particularly, to hand sanitizing stations that encourage usage of the stations and track the usage or non-usage. Sanitation stations disclosed herein are useful for prompting users to maintain clean hands when working in environments where clean and sanitized hands are vital.

### BACKGROUND OF THE INVENTION

There are many environments where it is imperative that people maintain clean hands. For example, unclean hands leads to a great deal of germ and disease transmission in places like health care environments, such as a hospital, clinic, or nursing home; schools; daycares; restaurant kitchens; restrooms, and others. The use of hand sanitizers is encouraged, but not mandated, in these locations. As a result, there is an ongoing problem of nosocomial infections, or infections that are acquired while in a hospital. Nosocomial infections result in longer hospital stays for patients, greater morbidity for patients who contract additional infections while in the hospital, and an avoidable mortality rate.

According to some studies, approximately ten percent of hospital patients are infected with a nosocomial infection during their stay, and 20,000 people in the United States alone die from them each year. These infections are largely transmitted to hospital patients from other patients, staff members, or visitors by poor hand sanitation techniques. The Center for Disease Control estimates that about 80% of infectious diseases are transmitted by touch, and the simple act of frequent hand sanitizing is the best protection from these types of illnesses. Of course, hospitals are not the only locations that could greatly benefit from improved hand sanitation techniques.

Schools are a notorious location for spreading germs between students. As students and faculty members exchange books, papers, pencils, lunch trays, use drinking fountains, computers, or the restroom, germs are being spread rampantly throughout the population. The same is true of food workers, who come into contact with food, utensils, plates, salt shakers, and doorknobs without proper sanitation techniques. As a person who is not immune to the germs comes into contact with them, it can lead to infection as the person touches their face, mouth, nose or rubs their eyes.

There are many simple things people can do to reduce the transmission of harmful germs, such as frequent hand washing with anti-bacterial soap. Another strategy is by using hand sanitizer gel or solution. However, while these opportunities may be readily available to the majority of the developed world's population, many people don't take full advantage of such opportunities. In addition, there are areas where adequate sanitation facilities are not readily available.

It would be an improvement, therefore, to have readily available sanitation stations that not only remind people to use them frequently and track the results of the use, but to also have a sanitation station that is self-contained and portable enough to be used in remote areas where sanitation is not always readily available.

### SUMMARY OF PREFERRED EMBODIMENTS OF THE INVENTION

A sanitizer dispensing and tracking system preferably includes a computerized controller in communication with a proximity sensor that is able to detect a user near the system. A speaker is able to play audible notifications such as to welcome a potential user, prompt usage of the system, play warnings for non-use of the system, or thank you messages. A dispenser contains a sanitizing solution and is able to dispense sanitizing solution to improve the hand hygiene of users of the system. A memory is also preferably included to store the incidents of usage and non-usage of the system.

The proximity sensor may be an infrared sensor and may be able to detect multiple people simultaneously. In this way, the system is able to remind each person in proximity to the system to practice appropriate hand hygiene and log the non-usage of each of the individuals who come in close proximity to the system. Of course, usage of the system may be stored in addition to incidents of non-usage. In one embodiment, the system is self-contained and operates on battery power, and is thus capable of being used in remote locations. In some embodiments, the system includes a network interface that allows the system to communicate with a local area network, such as for communicating with other similar systems on the premises, for storing information remotely such as on a server, and for remote monitoring of usage statistics, including, but not limited to, remaining volume of sanitizing solution and battery life.

In some embodiments of a sanitizer dispensing and tracking system, the proximity sensor is a RFID transceiver that is configured to read RFID tags and store information about the RFID tags, such as the identity of the tag and whether the owner of the tag used or didn't use the system appropriately to practice recommended hand hygiene.

The system may be configured to play audible messages, such as a welcome message, a reminder alert, and an alarm to indicate non-use of the system. The audible messages may be beeps or tones, a pre-recorded voice message, or a siren or oscillating tones. The system may optionally include a sensor configured to detect whether sanitizer has been dispensed. This allows the system to store information about usage or non-usage of the system, including the identity of non-users of the system in those embodiments that employ devices to track the identity of individual users.

The system may incorporate one or more UV lamps that are configured to illuminate a person's hands and illuminate the pathogens, such as bacteria, on the person's hands. A camera may be used to capture images of the illuminated bacteria for immediate or later image analysis to quantify the amount and/or type of bacteria present. The UV lamps may be configured to provide light at a desired one or more wavelengths chosen to fluoresce bacteria for image capture and analysis.

According to another embodiment, a method for encouraging hand sanitation and tracking compliance is provided, which includes detecting the proximity of a person, providing a notification to the person to sanitize their hands, detecting whether sanitizer was dispensed, after a predetermined period of time providing an alarm warning if sanitizer was not dispensed, and storing information about whether sanitizer was dispensed. The method may further include the step of collecting data about a user and whether the user appropriately used the sanitizing system to sanitize their hands. The method may further include the step of dispensing sanitizer on a user's hands. The dispensing step may be performed by activating an actuator to dispense a predetermined volume of sanitizer.

In one embodiment, the method further includes activating one or more ultraviolet lamps to illuminate a person's hands and capturing image of the illuminated hands. The method may optionally include the step of reading a unique identification of a user and storing information only if the person did not sanitize their hands.

### BRIEF DESCRIPTION OF THE DRAWINGS

Preferred and alternative examples of preferred embodiments are described in detail below with reference to the following drawings, of which:

FIG. 1 is a chart depicting the components of one embodiment of a sanitizing system.

FIG. 2 is a flow chart illustrating a sanitizing system in use.

FIG. 3 is a chart depicting the components of one embodiment of a sanitizing system.

FIG. 4 is a flow chart illustrating one embodiment of the sanitizing system in use.

FIG. 5 is a chart depicting the components of an embodiment of a sanitizing system.

### DETAILED DESCRIPTION OF PREFERRED EMBODIMENTS

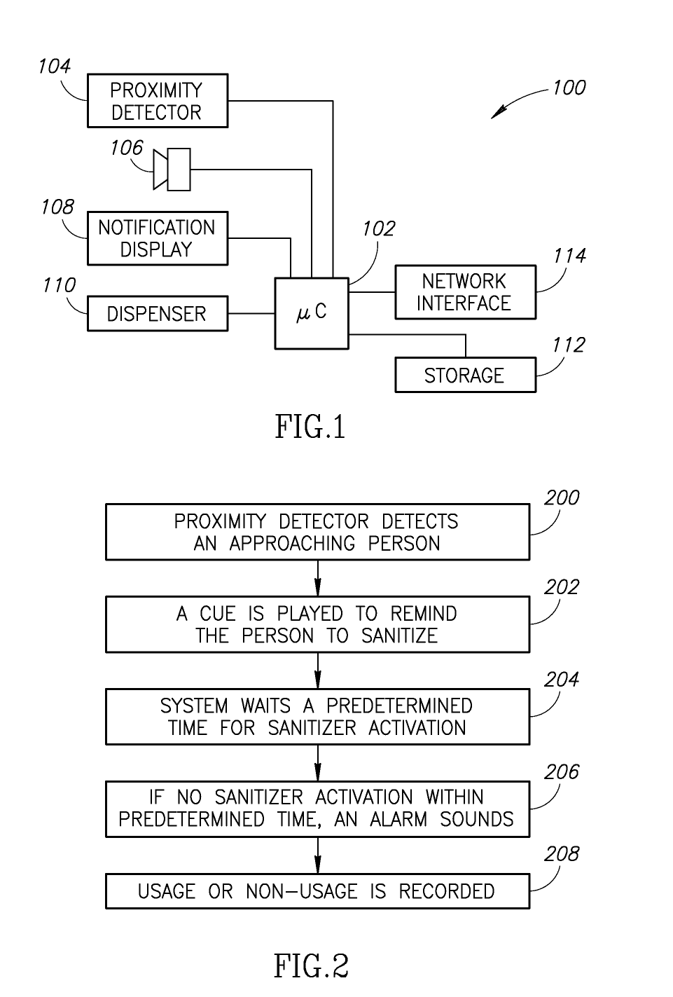

With reference to FIG. 1, one embodiment of a sanitizing station 100 is illustrated. Throughout the following description, the terms sanitizing station and sanitation station (also just station) may be used interchangeably, and are used to refer to the system being disclosed herein. The station 100 includes a microcontroller 102 programmable and configurable to operate the sanitation station 100 and its components. There are many specific microcontrollers currently available that are well suited for the disclosed application. One preferred configurable microcontroller is the Raspberry Pi system distributed by the Raspberry Pi Foundation, which allows accessories to be added to the system through its GPIO pins, HDMI jack, USB ports, graphics port, and memory slot. A proximity sensor 104 is in communication with the microcontroller 102 and is configured to detect the approach of a person. The proximity sensor 104 can be any suitable sensor for detecting the approach or presence of a person, but in some embodiments, the proximity sensor 104 is an IR sensor that is able to distinguish between a person, and an inanimate object such as a gurney, wheelchair, or other object. In other embodiments, the proximity sensor 104 is a radio frequency module that is able to detect the presence of a unique radio frequency identifier, such as may be embedded in a hospital worker's employee badge. Many healthcare facilities are following a standard for employee badge, such as the ISO 18000-6c standard, and by creating a system that cooperates with this standard, stricter tracking and hand hygiene control is achievable. By using RFID technology, the sanitizing system 100 can accurately determine usage or non-usage statics specific to each employee. Corrective efforts can then be taken to increase effective usage of the system with each employee.

A speaker 106 is coupled to the microcontroller 102 and is configured to broadcast audio messages relating to the sanitizing system 100. For example, the speaker 106 can be configured to broadcast an audible series of tones as a reminder to an approaching person to use the sanitizing station 100 to ensure their hands are clean before proceeding. The speaker can likewise be used to broadcast a warning or alarm if someone passes by the station 100 without using the hand sanitizer to ensure clean hands and compliance with any relevant facility protocols. Moreover, as the sanitizing station 100 acquires information about the individuals within its proximity, it can call out audible warnings and call the people by name and request that they properly sanitize their hands before proceeding. The warnings may also take on multiple sounds, such as beeps, sirens, the sound of water running, dogs barking, birds chirping, or any such sound designed to get the attention of a person walking past the sanitizing station without properly using it.

In some embodiments, a notification display 108 is coupled to the microcontroller 102 and can be used for a multitude of purposes. For example, the notification display 108 may be one or more lights configured to visually alert an approaching person of the need to sanitize their hands. It can be configured with various colors of light, for example, red and green, to indicate whether someone is safe to proceed after using the sanitizing station 100. In other embodiments, the notification display 108 is a video screen or monitor that can be used to display written or pictorial messages reminding someone about the need to sanitize and/or thanking them for their proper use of the system 100. In other embodiments, the notification display 108 may be a touch screen display that can be used to enter information such as an employee number, effecting an override of the system, or displaying information about the system, such as remaining battery life, storage space, or the level of remaining sanitizer.

The microcontroller 102 is also coupled to a dispenser 110 that includes a reservoir for storing the sanitizing solution, and a sensor for detecting when the dispenser 110 has been used. In some embodiments, the dispenser 110 incorporates an actuator and a hand sensor so that it can be used hands-free. More specifically, the dispenser can be configured such that when a person locates their hand in the proper position, the sensor detects the proper hand position and triggers the actuator to dispense sanitizing solution on the properly located hand. The sensor also sends usage information to the microcontroller 102 which can store this data in memory storage 112. The sanitizing solution is preferably any suitable anti-bacterial solution or gel capable of sanitizing a user's hands. Many preparations of hand sanitizer or hand antiseptic are available including gel, foam, and liquid solutions. The active ingredient in many of these sanitizers may be isopropyl alcohol, ethanol, n-propanol, or povidone-iodine. Many of these sanitizers also include additional inactive ingredients to influence the viscosity, add fragrance, or provide skin-softening lotions. All such preparations are suitable for use within the disclosed sanitation stations. Moreover, in some embodiments, the reservoir will accept a container of hand sanitizer in the original manufacturer's packaging. For example, many commercially available hand sanitizing products are sold in plastic bottles having a threaded neck and a lid or pump head attached thereto. The reservoir may be configured to allow the threaded neck of a commercially available hand sanitizer bottle to be directly connected. Additionally, the reservoir may allow a pump-style hand sanitizer bottle to be directly inserted into the reservoir for dispersal through the included pump.

The microcontroller 102 is preferably in communication with a storage device 112, such as a hard drive or a secure digital card, such as a SD card, a micro SD card, or other suitable storage device. The memory storage device 112 stores information related to the sanitizing station 100 such as the usage statistics of the station and may include one or more of the following types of information: the unique station identification, the date and time of operation, the identity of the user, the amount of sanitizer remaining in the reservoir, the date the sanitizer reservoir was refilled or replaced, as well as non-use statistics. The non-use statistics become important when a facility is interested in learning about its personnel's hand sanitizing habits. The station is able to detect when a person approaches the station and then chooses not to use the available hand sanitizer. Based upon the non-use statistics, a facility can promote efforts at increasing sanitizing station usage which can have a direct effect on limiting the propagation of pathogens.

A network interface 114 may be provided to allow the sanitizing station 100 to be in communication with a network to allow for (1) usage statistics to be transmitted and stored on a remote storage device, (2) send notifications when the sanitizer reservoir gets low, (3) send notifications when the AC power is disconnected or the battery capacity runs low, or (4) allow communication between sanitizing stations at different locations. Of course, in some remote locations, network communication may not be available, so this feature is optional. The network interface may be provided as an Ethernet jack, such as a RJ45 jack to allow Ethernet communications, or may be a Wi-Fi adapter with an antenna for wireless communication over a local area network.

With reference to FIG. 2, one possible flow chart is illustrated as an example of how the novel hand sanitizing dispensing and tracking system may be configured. In use, at block 200, a proximity detector detects an approaching person. A cue is played to remind the person to sanitize at block 202. The cue may be in the form of an audio signal, a visual signal such as flashing lights, displayed text or pictorial messages, or both. At block 204, the system is configured to wait a predetermined amount of time to allow the approaching person to dispense hand sanitizer. If the dispenser is actuated and dispenses hand sanitizer within the predetermined allotted time, the system is reset and waits for the next approaching person. However, if the dispenser is not actuated, an alarm may be triggered at block 206. The alarm may be audio, visual, or both. The alarm is preferably designed to get the persons attention to remind them again to sanitize their hands. If the person dispenses hand sanitizer, the alarm stops and the system resets. If the person does not use the sanitizing system, the alarm continues for a predetermined time and the non-usage of the system is recorded at block 208. Optionally, the alarm may be programmed to decrease in volume as the person moves away from the sanitation station 300 such that once they are out of range of the proximity sensors, the alarm is silent. Of course, the system may be configured in a myriad of ways. For example, the cue and/or alarm may be escalating as time passes without the person dispensing the sanitizer. The system may also be overridden for a period of time, such as when there will be a high frequency of traffic past the system in a short period of time, such as when there is an emergency and it may not be advisable for every person passing the system to stop and sanitize. The manual override may be effected by an employee typing in a code, or presenting a proximity card such as an employee badge, or by swiping a magnetic striped card through a card reader attached to the system.

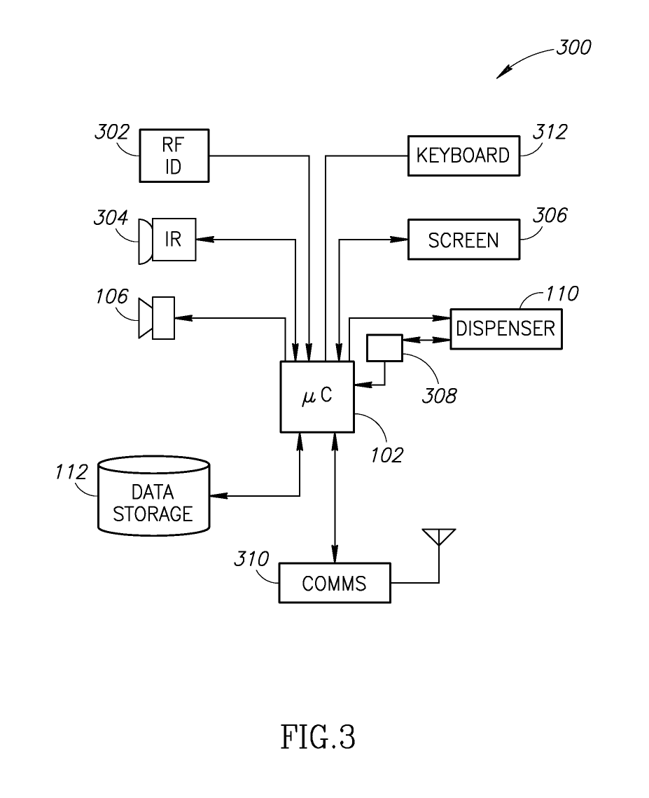

With reference to FIG. 3, a sanitation station 300 is illustrated that utilizes a microcontroller 102 to control the system and its components. The microcontroller 102 preferably contains all the processing, memory, and interfaces needed for supporting the functionalities of the various components. The components that are in communication with the microcontroller 102 include a RFID transceiver 302, an IR camera 304, a speaker 106, a keyboard 312, a screen 306, a dispenser 110, a dispenser sensor 308, a data storage device 112, and a communication unit 310. It should be appreciated that these components may be connected to the microcontroller 102 and interconnected by wired connections, wireless connections, or a combination thereof.

The microcontroller 102 is preferably programmed with instructions that allow it to control the various components and to receive feedback from many of them. For example, the microcontroller communicates with the RFID transceiver 302 and receives information about RFID tags that come into proximity with the sanitation station 300. The RFID transceiver 302 is controlled to detect the presence of an RFID tag, such as may be provided in an employee badge, or other device that contains information about the worker, and more specifically, is programmed to detect the presence of a RFID tag within a predetermined range, such as within 2 feet (0.6 meters), or 3 feet (1 meter), or 4 feet (1.2 meters), or 5 feet (1.5 meters), or more.

The RFID transceiver 302 is configured to detect the presence of an RFID tag and provide information unique to the tag to the microcontroller 102, which causes this information to be stored in memory. The information collected by the RFID transceiver 302 may include a unique employee ID, and this will be stored by the microcontroller 102 along with other useful information, such as, for example, the date, time, location, and whether the sanitation station 300 was used. As an alternative to known RFID tag and transceiver technologies, the station may rely on other forms of near field communication technology, or NFC technology. In some embodiments, NFC chips are used to detect the proximity of a person and to even identify that person in some instances. For example, NFC technologies allow smart phones and other devices to establish radio communication with each other by bringing them into proximity with each other. In this way, a sanitation station can determine the identity of a person by the smart phone they carry with them, and then track sanitation station usage statics on an individual level. Similarly, proximity cards can be used with the same effect. A proximity card uses passive electromagnetic induction embedded in a device such as a tag, sticker, key fob, or card and does not need power such as from a battery. In those embodiments which rely on proximity identification of the individual, any suitable technology, even future emerging technology, may be utilized to communicate basic information about the user to the system.

The microcontroller 102 may additionally be in communication with an IR camera 304. As used herein, the term IR camera means any device capable of detecting IR energy, such as a thermal infrared camera, an infrared sensor, or other device that can detect the proximity of a heat source. Suitable cameras for use with the disclosed embodiments are the Omron D6T or the Melexis MLC90614, for example. These cameras are advantageously tuned to recognize the heat signature of human wavelength, and are able to effectively detect multiple humans within the target environment. The cameras integrate MEMS and ASIC technologies to achieve high signal to noise ratios and minimize false positives. The IR camera 304 can be used to detect the approach of a person by using infrared wavelength signals, such as heat signatures. This is particularly useful in environments where it is desirous to detect people who do not carry RFID tags, such as visitors to a hospital, or in facilities that do not use RFID tags. IR cameras 304 are widely available commercially, and any suitable IR detector may be used in combination with the embodiments that provide IR detection. While some embodiments utilize only a RFID transceiver 302, and other embodiments may utilize only an IR camera 304, some embodiments utilize both a RFID transceiver 302 and an IR camera 304. The embodiments that utilize both a RFID transceiver 302 and an IR camera 304 allow a facility to track the hand-sanitation habits of employees who may carry RFID tags as well as facility visitors and others who may not carry RFID tags. In this way, a facility is able to monitor the overall usage of the hand sanitation stations by everyone who may come into contact with patients and take measures to improve hand sanitation habits if the facility finds that there is an unacceptably large incidence of non-usage. In addition, this type of individual tracking prevents bypassing the system by one person occupying the system while others simply walk by. The system is able to detect multiple people passing simultaneously and providing alarms for each occurrence of non-use. In some cases, the system can provide individual alarm notifications, such as by using a person's name, or badge number, or employee ID, or other indicia that may be unique to each individual who passes by the system without properly sanitizing.

A speaker 106 is controlled by the microcontroller 102 and is configured to provide audio. For example, the microcontroller 102 may cause the speaker to play an audible greeting when someone approaches the sanitation station 300, and may also be configured to play an audible signal to indicate proper usage or non-usage of the sanitation station 300. In some embodiments, the speaker 106 will sound an alarm if a person in proximity to the sanitation station 300 does not properly sanitize their hands. The alarm will preferably play for a fixed duration after which time it will be turned off and the system will be readied for the next user. The speaker 106 may also play at a variable volume based upon factors such as the proximity of a person to the sanitation station 300, the time that the alarm has been active, a bypass code being entered, or other external factors such as high traffic emergency care in which the sanitation station 300 may be repeatedly bypassed by emergency responders. The speaker may also be used to provide additional information, such as when the sanitizer reservoir in the dispenser 110 gets low, or if the batteries are low in those embodiments that rely on battery power.

Optionally, a screen 306 may be connected to the microcontroller 102 through a suitable connection. The screen 306 may be configured to play graphical and/or textual indicia to a person, such as to alert an approaching person to use the sanitation station 300, a thank you message after proper usage, a warning message for non-use, or other relevant information such as how much sanitizer remains in the reservoir, the remaining battery life, the unique identification of the sanitation station, or other relevant information. The screen 306 may also be configured as a touch screen to accept user input. Optionally, an external keyboard 312 may be in communication with the microcontroller 102 and configured to provide input to the system 300. They keyboard 312 may be a standard QWERTY keyboard, or may provide a numeric keypad for data entry. The keyboard 312 may be used to enter information into the system, such as initializing the system, providing network security passwords to allow the sanitizing station to connect to a secured local area network, or for providing user information or override commands to the system.

A dispenser 110 is in communication with the microcontroller 102 and has a reservoir for storing sanitizing solution and is in further communication with a dispenser sensor 308. The dispenser 110 is responsible for dispensing sanitizer to users of the system. The dispenser sensor 308 is able to track how many times the dispenser has been used over a given time period, and as such, can also be used to track the remaining volume of sanitizer in the reservoir. In some embodiments, the dispenser 110 contains an actuator (not shown) that will automatically dispense a proper amount of hand sanitizer when someone places their hands in the correct location relative to the dispenser. In other embodiments, the user manually actuates the dispenser, such as by pressing a button, lever, or actuating a pump. The sensor 308 is preferably configured to track each usage of the dispenser 110 and relay this information to the microcontroller 102 for statistical usage storage.

A communication unit 310 may be included with the system 300 that is able to provide information to other devices outside the system 300. The communication unit 310 may include an Ethernet jack to allow wired connection to a local area network, or may alternatively or additionally include a Wi-Fi adapter to provide for wireless communications to a local area network. In either case, the communication unit 310 allows the system 300 to communicate with other sanitizing stations, with central servers that can monitor the sanitation station usage and vital statistics, and for remote storage of usage statistics.

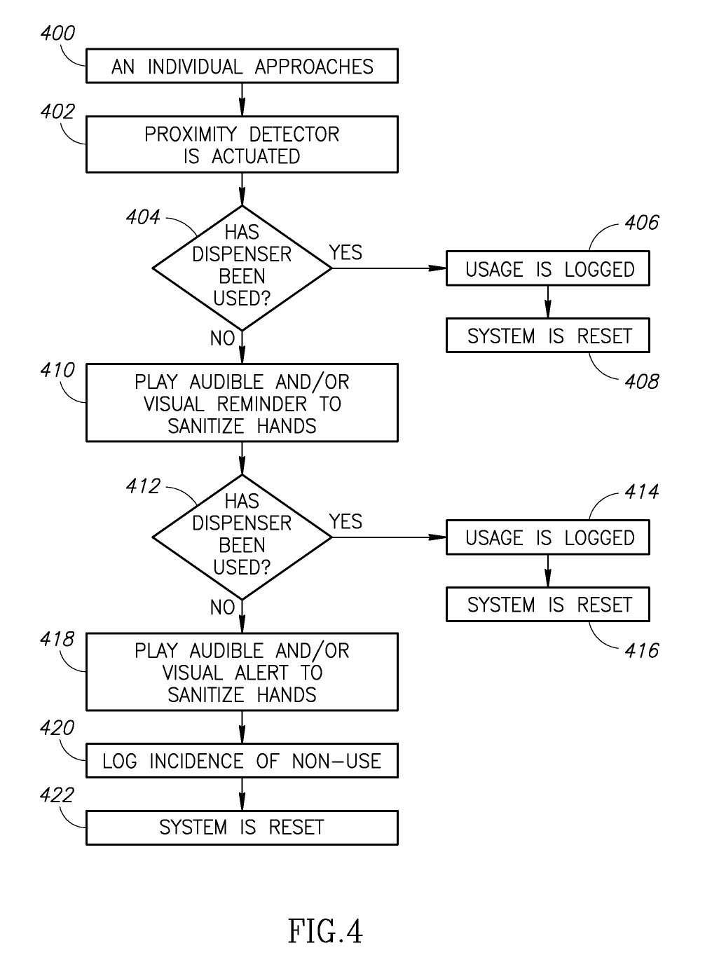

FIG. 4 illustrates, in its simplest form, the logic flow of the sanitation station. At block 400 the system is ready and its sensors are actively looking for an approaching person. Once an individual approaches and is within the detection zone, the proximity detectors are actuated at block 402. At this point, the system may prompt the person to use the sanitation station such as through audio and/or visual cues. After a predetermined time, the system checks to see whether the dispenser has been used. If yes, the usage is logged to memory at block 406 and the system is reset at block 408 to await another user.

If the dispenser has not been used after a predetermined time, at block 410, an audible and/or visual reminder is played to encourage the user to sanitize their hands. The system again waits a predetermined time before querying whether the dispenser has been used. If so, the usage is logged at block 414 and the system is reset at block 416 and is ready to receive another user. If the dispenser has not been used after a predetermined time, an audible and/or visual alert plays to warn the person that they need to sanitize their hands. The system then queries the dispenser for activation and then logs the incidence of usage or non-use at block 420 and the system is reset at block 422. This figure represents a simplistic operational view of the system, and it should be appreciated that there are many alternative or optional steps that may be involved in the operation of the system.

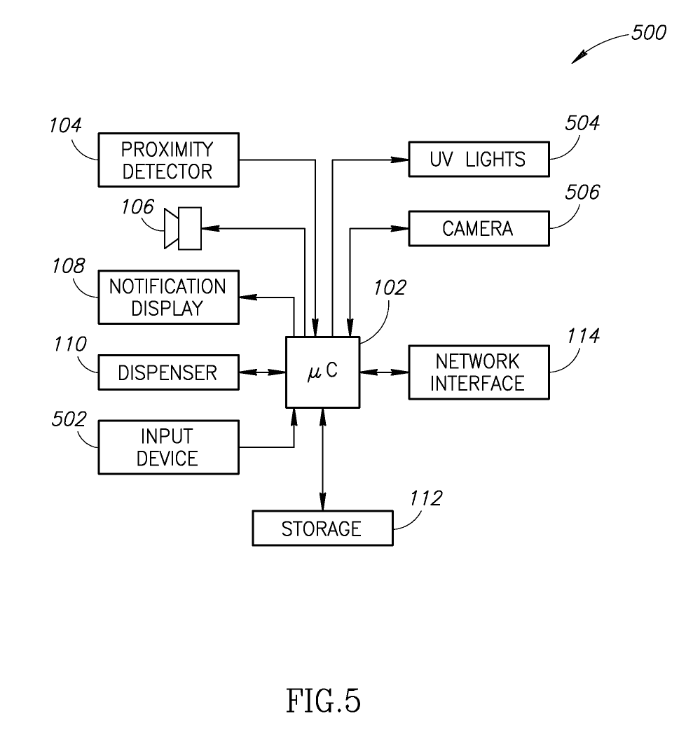

Referring to FIG. 5, another embodiment of a sanitation station 500 is depicted. This embodiment has many of the same components as other embodiments that have been described, but has additional components added as well. The microcontroller 102 is configured to interact with and control the various components of the system 500. As has been previously described, the system 500 preferably includes one or more proximity detectors 104, a speaker 106, a notification display 108, a dispenser 110, an input device 502, a memory storage 112, and a network interface 114. In this embodiment, the system 500 is further configured with one or more UV lights 504.

It is known that certain pathogens will fluoresce under various wavelengths of UV light. The system 500 can be configured to measure and record the amounts and types of bacteria found on users hands. To this end, the system is outfitted with one or more UV lamps 504 of desired wavelengths that will cause certain bacteria to fluoresce. A camera 506 may also be provided to capture images of the fluorescing bacteria. As a user places their hands in the appropriate position for using the sanitation station 500, one or more of the UV lights will be activated and the camera will capture one or more images of the user's hands before sanitizer is dispensed. This process may take upwards of one second, or half a second, or even one hundredth of a second or less in order to capture images of the contaminants being carried by the user. Preferred UV lights may include a UV-A lamp, which has been shown to cause some bacteria to fluoresce, for example, corynebacterium minutissimum appears red, while pseudomonas appears yellow-green under the long-wave ultraviolet light. Other bacteria fluoresce under different wavelengths of light in the ultra violet spectrum, so other UV lamps that emit UV light at alternative wavelengths are also contemplated.

The camera is configured to cooperate with the UV lamps to capture images while the UV lamps are active, thus providing a way to visually assess the quantity and type of pathogens contained on a person's hands. This can be used as a useful indicator to assess the level of contamination and types of pathogens that are being distributed throughout the facility. The system 500 may include the ability to parse the captured images to automatically determine the quantity and type of contaminants contained on a person's hands before they are sanitized.

The various embodiments disclosed herein are merely examples of sanitation stations contemplated. In many embodiments, it is preferable that each sanitation station is a self-contained device. That is, an outer housing is sized and shaped to hold the various components. There are certain components that may be located on the exterior of the housing, or fit within openings in the housing so as to allow interaction with the surrounding environment. For example, the proximity detectors and camera will need to have a line of sight that is outside the housing. Moreover, the dispenser, notification display, and any input devices will need to allow user interaction, so they are not wholly contained inside the housing. That said, the housing is preferably configured to secure all of the integrated components and is capable of being mounted, for example, on a wall, on an IV stand, on a patient bed, or some other suitable support structure. In many embodiments, the system is powered by batteries, thus making the station portable and able to be located nearly anywhere, even in remote locations where electricity may not be readily available or reliable.

In one preferred application, a sanitation station is supplied at the doorway to each hospital room. Thus, as a healthcare worker or visitor enters a patient room, they are prompted to sanitize their hands before proceeding. However, many hospitals utilize shared rooms with more than one bed per room. Sanitation station may also be located on each patient's bed or IV stand, so that as a healthcare worker moves from patient to patient, even within the same room, they are prompted to sanitize their hands to reduce the occurrence of patient-to-patient disease transmission.

While several preferred embodiments of the invention have been illustrated and described, as noted above, many changes can be made without departing from the spirit and scope of the invention. Accordingly, the scope of the invention is not limited by the disclosure of the preferred embodiments. Moreover, some of the components described in relation to the disclosed system are optional and may not be preferable for all usages, and while the disclosure herein may focus on a system useful for one particular application, this should not be construed as limiting on the invention as a whole. Instead, the invention should be determined entirely by reference to the claims that follow. The embodiments of the invention in which an exclusive property or privilege is claimed are defined as follows:

1. A sanitizer dispensing and tracking system, comprising:
a computerized controller in communication with a proximity sensor configured to detect a person in close proximity to the system, a speaker configured to relay audible notifications, a dispenser containing a sanitizing solution, and a memory storage for logging the incidents of usage and non-usage of the system.

2. The sanitizer dispensing and tracking system of claim 1, wherein the proximity sensor is an infrared sensor configured to detect the proximity of multiple people simultaneously.

3. The sanitizer dispensing and tracking system of claim 1, wherein the system is self-contained within a housing and operates on battery power.

4. The sanitizer dispensing and tracking system of claim 1, further comprising a network interface for allowing the system to communicate with a local area network.

5. The sanitizer dispensing and tracking system of claim 1, wherein the proximity sensor is a RFID transceiver configured to read a RFID tag associated with a user of the system and the system is configured to store information about the user's use or non-use of the system.

6. The sanitizer dispensing and tracking system of claim 1, wherein the system is configured to play one or more of an audible welcome message, a reminder alert, and an alarm to indicate non-use of the system.

7. The sanitizer dispensing and tracking system of claim 6, wherein the one or more of an audible welcome message, a reminder alert, and an alarm to indicate non-use of the system are in the form of beeps or tones, pre-recorded voice messages, or oscillating pitches.

8. The sanitizer dispensing and tracking system of claim 1, further comprising a sensor configured to detect whether sanitizer has been dispensed.

9. The sanitizer dispensing and tracking system of claim 1, further comprising one or more UV lamps configured to illuminate bacteria and a camera configured to capture images of the bacteria.

10. The sanitizer dispensing and tracking system of claim 9, wherein the UV lamps are configured to shine light at a desired wavelength that will cause bacteria to fluoresce, and the camera is configured to capture images of the fluorescing bacteria.

11. A method for encouraging hand sanitation and tracking compliance, the method comprising the steps of:
detecting the proximity of a person;
providing a notification to the person to sanitize their hands;
detecting whether sanitizer was dispensed;
after a predetermined period of time, providing an alarm warning if sanitizer was not dispensed; and
storing information about whether sanitizer was dispensed or not.

12. The method of claim 11, further comprising the step of collecting data about a user and storing the data about the user and whether the user dispensed sanitizer or not.

13. The method of claim 11, further comprising the step of dispensing sanitizer onto a user's hands.

14. The method of claim 13, wherein the step of dispensing sanitizer comprises activating an actuator to dispense a predetermined volume of sanitizer.

15. The method of claim 11, further comprising the step of activating an ultraviolet lamp to illuminate a person's hands and capturing an image of the illuminated hands.

16. The method of claim 11, further comprising the step of reading unique identification information about a person and storing this information in memory only if the person did not sanitize their hands.
